(19) United States
(12) Patent Application Publication
(10) Pub. No.: US 2007/0071978 A1
(43) Pub. Date: Mar. 29, 2007

(54) Cosmetic Composition Containing Thermoplastic Microspheres and Skin Beneficial Agents

(76) Inventors: Milan F. Sojka, Coram, NY (US); Phillip Cummins, Livingston, NJ (US)

Correspondence Address: THE ESTEE LAUDER COS, INC, 155 PINELAWN ROAD, STE 345 S, MELVILLE, NY, 11747, US

(21) Appl. No.: 11/534,074

(22) Filed: Sep. 21, 2006

Related U.S. Application Data
(60) Provisional application No. 60/720,026, filed on Sep. 23, 2005.

(51) Int. Cl. B32B 9/00

(52) U.S. Cl. 428/402.2

(57) ABSTRACT

The invention relates to thermoplastic hollow microspheres containing one or more skin benefit agents entrapped therein. The microspheres are useful in the topical delayed release of the skin benefit agent.

This application claims the benefit of U.S. Ser. No. 60/720,026, filed Sep. 23, 2005.

### FIELD OF THE INVENTION

The invention relates to topical compositions for application to the skin. More specifically, the invention relates to cosmetic compositions for delivery of skin benefit agents to the skin.

### BACKGROUND OF THE INVENTION

The average individual's skin is in nearly constant need of improvement in some way or another. The cosmetics industry is in constant search for new materials that will overcome one or another of the skin's deficiencies, such as dryness, uneven coloration, oiliness, acne, redness, or dark spots, or enhance its natural appearance, such as by coloring, tanning or brightening. Great strides have been made in recent years in identifying active ingredients to alleviate or eliminate many common skin problems, as well as finding optical solutions to disguise imperfections that cannot easily be removed.

Finding a product that solves a particular skin problem, however, does not end the task. The next step in the process is to determine how best to deliver the product of interest to the desired target with a minimum of difficulty and discomfort to the user, and once delivered, how best to keep it at the target and retain its stability so it will continue to deliver the desired benefit. Simple placement of a product on the target is not necessarily all that is required. Skin is a complex organ, composed of both living and dead cells, and it is constantly engaged in physiological processes or exposed to physical conditions that will often militate against the retention of product and its activity, or which may cause the user physical discomfort when the product is applied. For example, perspiration and oil on the skin can effectively wash away a product; depending on physiological conditions, a product may migrate from one skin cell layer to another, which may defeat the purpose of its initial application; and physical contact, such as showering, high humidity, or rain, can also cause removal of makeup or skin treatment agents, while exposure to light often has damaging effects on an active ingredient. In addition, contact with incompatible chemical agents may cause an active to lose potency, even if it does remain in place. Thus, in applying a product, the cosmetic formulator must consider what additional components can be provided to the formulation to ensure that the cosmetic active or appearance-enhancing material reaches and stays at the targeted spot, while still retaining the ability to perform its expected function.

The challenge to provide a mechanism for such topical targeting is great. Many established methods, such as skin patches, are effective in targeting, but are often bulky, highly visible, and inconvenient to use. Encapsulation is another frequently employed means for stabilization and delivery of skin benefit agents. Several challenges are often met with encapsulation as well: physical entrapment of a skin benefit agent can often have an adverse effect on the potency of the agent, and depending on the chemical and/or physical nature of the capsules, the resulting product may not retain the cosmetic elegance that is preferred by most consumers. Thus, there is continuing need for the development of delivery systems that not only achieve the desired targeting and delivery of an active or other skin benefit material to the proper site on the skin, but also stabilize the agent while not interfering with its activity. The present invention provides a novel means for delivery of skin benefit agents which achieves these advantages as well as others, while retaining the ability to produce an aesthetically pleasing product.

### SUMMARY OF THE INVENTION

The invention relates to a topical composition comprising thermoplastic hollow microspheres having at least one skin benefit agent entrapped therein.

The invention also provides a mechanism for delayed release of a skin benefit agent on the skin, comprising applying to the skin a hollow thermoplastic microsphere in which the skin benefit agent is entrapped.

In certain embodiments, the microspheres are coated with a polymeric coating, such as a polymeric silicone or crosslinked polyvinyl alcohol. Such coated microspheres are particularly useful in preventing certain types of entrapped agents, such as colorants, from migrating from their intended target.

### BRIEF DESCRIPTION OF THE DRAWINGS

FIGS. 1a, b and c are graphs demonstrating the chemical stability protection of an active by encapsulation in thermoplastic microspheres;

FIG. 2 is a graph demonstrating the controlled release of an active contained in microspheres under pressure;

FIG. 3 is a graph demonstrating the controlled release of an active contained in microspheres under pressure;

FIG. 4 is a graph demonstrating the controlled release of an active contained in microspheres under pressure;

FIG. 5 demonstrates lack of bleeding of an entrapped colorant after suspension in solvent for 4 hours;

FIG. 6 demonstrates lack of bleeding of an entrapped colorant after suspension in solvent for 4 days;

FIG. 7 is a graph demonstrating the increase in fluorescent activity of an optical brightener entrapped in coated microspheres;

FIG. 8 is a graph demonstrating the increase in fluorescent activity of an optical brightener entrapped in coated microspheres;

FIG. 9 is a graph demonstrating the increase in fluorescent activity of an optical brightener entrapped in coated microspheres; and

FIGS. 10a, b and c demonstrate reduction in the appearance of skin imperfections after treatment of the skin with a cosmetic composition containing microsphere entrapped fluorescent brightener.

### DETAILED DESCRIPTION OF THE INVENTION

The microspheres of the invention are thermoplastic expandable particles having a hollow core. The basic microsphere technology is described in U.S. Pat. Nos. 3,615,972; 3,864,181; 4,006,223; 4,044,176; 4,397,799; 4,513,106; 4,722,943; and EP 056219 and 112807, the contents of each being incorporated herein by reference. The microspheres can be made from a variety of different types of materials, for example polymers or copolymers of alkenyl aromatic monomers, such as styrene, methylstyrene, ethylstyrene, aromatic vinyl-xylene, aromatic chlorostyrene, aromatic bromostyrene; acrylate monomers, such as methyl methacrylate, ethyl acrylate, propyl acrylate, butyl acrylate, butyl methacrylate, propylmethacrylate, butyl methacrylate, lauryl acrylate, 2-ethylhexyl acrylate, or ethyl methacrylate; vinyl esters, such as vinyl acetate; and copolymers of vinyl chloride and vinylidene chloride, acrylonitrile with vinyl chloride, or bromide. Particularly preferred are microspheres composed of acrylonitrile/methacrylonitrile/methylmethacrylate polymer, acrylonitrile/methacrylonitrile polymer, and acrylonitrile/vinylidene Chloride polymer. Such materials are selected so as to impart the microspheres with a desirable absorption capacity for the skin benefit agent, as well as flexibility and resistance to shear stress. The microspheres useful in the invention have a particle diameter of from about 1μ to about 200μ, preferably about 5 to about 100μ, more preferably about 5 to about 50μ; however, it will be understood that the preferred particle size will depend on the nature of the material to be incorporated therein.

Microspheres of this type are commercially available, and a preferred microsphere is the type known by the trade name Expancel, sold by Akzo Nobel. A particularly preferred type of microsphere is that provided under the commercial name Expancel DE or Expancel WE.

Microspheres as described above, as manufactured, have a hollow core that is occupied by a gas, which is typically a hydrocarbon gas such as butane or pentane, or air. In the compositions of the present invention, and unlike the previous cosmetic uses of these microspheres, at least a portion of that gas is replaced by a skin benefit agent. The modification of the microspheres so as to allow them to take in the skin benefit agent is achieved by opening pores on the surface with solvent. The appropriate solvent will be a matter of choice depending on the chemical composition of the particle; a solvent should not be selected which will dissolve or break the particles. Preferred solvents for this purpose are solvents that are not strongly polar; examples of solvents that will be useful over a range of different microsphere compositions are ethanol, hydrocarbons, such as hexane or heptane, esters, such as ethyl acetate, and volatile silicones, such as cyclomethicone or low molecular weight dimethicone. Examples of strongly polar solvents that are specifically not recommended are compounds such as acetone, DMF, DMS, or strong mineral acids or bases. While not wishing to be bound by any theory, it is believed that the solvent aids in opening preexistent pores in the microspheres, which they allow entry of solvent containing the skin benefit agent.

Within the range of recommended solvents, the particular solvent used will preferably be chosen depending upon the solubility parameters of the skin benefit agent to be conveyed to the core of the microsphere. The skin benefit agent is dissolved or dispersed in the solvent prior to contact with dry microspheres (if the starting microspheres are the WE type mentioned above, it is preferred to first dry them before contact with the solvent), in an amount that is not critical, but typically coincident with the level of solubility of the agent in the solvent. The solvent containing the skin benefit agent (it may be more than one such agent) is then exposed to the microspheres for a period of time sufficient to obtain substantially homogeneous absorption, typically about thirty minutes. The amount of agent/solvent mixture relative to the amount of microspheres is not crucial, but an efficient ratio for absorption is about 8:1. Preferably, the microsphere-solvent combination is lightly mixed, typically at a speed of about 10-50 rpm.

Preferably, once absorption is completed, all or most of the solvent is evaporated off, although in some cases, if the solvent is one which has a skin benefit itself, such as water, it may be desirable to leave some or all of the solvent associated with the microspheres for further formulating. The resultant product, which may range from a dry flowable powder when a solid, such as a crystalline salicylic acid or a metal oxide is entrapped, to a wetter particulate mass when a fluid is entrapped, can then be used directly in a cosmetic formulation.

The term “skin benefit agent” as used in connection with the present invention is intended to encompass any number of different materials that perform a desired or beneficial function when applied to any keratinous surface, including not only the skin, but also the hair or nails. In the most traditional sense, the term encompasses skin, hair or nail care active ingredients, i.e., those which exert some biological or biochemical effect on the keratinous surface. Examples of such materials include but are not limited to, astringents, such as clove oil, menthol, camphor, eucalyptus oil, eugenol, menthyl lactate, witch hazel distillate; antioxidants or free-radical scavengers, such as ascorbic acid, its fatty esters and phosphates, tocopherol and its derivatives, N-acetyl cysteine, sorbic acid and lipoic acid; anti-acne agents, such as salicylic acid and benzoyl peroxide; antimicrobial or antifungal agents such as caprylyl glycol, triclosan, phenoxyethanol, erythromycin, tolnaftate, nystatin or clortrimazole; chelating agents, such as EDTA; topical analgesics, such as benzocaine, lidocaine or procaine; anti-aging/anti-wrinkle agents, such as retinoids or hydroxy acids; skin lightening agents, such as licorice, ascorbyl phosphates, hydroquinone or kojic acid), antiirritants, such as cola, bisabolol, aloe vera or panthenol, anti-inflammatories, such as hydrocortisone, clobetasol, dexamethasone, prednisone, acetyl salicylic acid, glycyrrhizic acid or glycyrrhetic acid; anti-cellulite agents, such as caffeine and other xanthines; skin-conditioning agents, for example, humectants, such as alkylene polyols or hyaluronic acid, or emollients, such as oils, oily esters or petrolatum; sun protecting agents (organic or inorganic), such as avobenzone, oxybenzone, octylmethoxycinnamate, titanium dioxide or zinc oxide; exfoliating agents (chemical or physical), such as N-acetyl glucosamine, mannose phosphate, hydroxy acids, lactobionic acid, peach kernels, or sea salts; self-tanning agents, such as dihydroxyacetone; Vitamins, such as B, C, D and E vitamins and their derivatives, and biologically active peptides, such as palmitoyl pentapeptide or argireline.

In addition, “skin benefit agents” is intended to refer to materials which otherwise benefit or enhance the skin, without necessarily having any biological effect. Examples of such materials include those which visually alter the skin's appearance, such as colorants and pigments, including both inorganic and organic colorants and pigments. Any color Examples of useful pigments include iron oxides (any color, including yellow, red, brown or black), titanium dioxide (white), zinc oxide, chrome oxide (green), chrome hydrate (green), ultramarines, manganese violet, ferric ferrocyanide, carmine 40, ferric ammonium ferrocyanide, or combinations thereof. Interference pigments, which are thin plate like layered particles having a high refractive index, which, at a certain thickness, produce interference colors, resulting from the interference of typically two, but occasionally more, light reflections, from different layers of the plate, can also be added to provide a pearlescence to the product, if such is desired.

Organic pigments may also optionally be included; these include natural colorants and synthetic monomeric and polymeric colorants. Exemplary are phthalocyanine blue and green pigment, diarylide yellow and orange pigments, and azo-type red and yellow pigments such as toluidine red, litho red, naphthol red and brown pigments. Also useful are lakes, which are pigments formed by the precipitation and absorption of organic dyes on an insoluble base, such as alumina, barium, or calcium hydrates. Particularly preferred lakes are primary FD&C or D&C Lakes and blends thereof. Stains, such as bromo dyes and fluorescein dyes can also be employed.

Another skin benefit agent category is fluorescent or other light emitting materials. Such materials may have benefit in terms of the optical effects of fluorescence on the skin, as well as therapeutic benefits due to light emission. In particular, and as described in U.S. Pat. Nos. 6,313,181, 6,753,002 and 6,592,882, the contents of which are incorporated herein by reference, fluorescent materials can provide benefits in disguising the symptoms of aging (chrono- or photoaging), such as lines, wrinkles, dark circles or shadows, or also can act as skin color adjusters or correctors. Examples of such fluorescent materials include but are not limited to fluorescent mineral powders with green fluorescence, such as andalusite and chiastolite (aluminum silicate); amblygonite (basic lithium aluminum phosphorate); phenakite (beryllium silicate); variscite (hydrous aluminum phosphate); serpentine (basic magnesium silicate); amazonite (potassium aluminum silicate); amethyst(silicon dioxide); chrysoberyl (beryllium aluminum oxide); turquoise (copper-containing basic aluminum phosphate); colorless, yellow or pink tourmaline (borosilicate); amber (succinite/various resins); opal(hydrous silicon dioxide); cerussite (lead carbonate); fuchsite (potassium aluminum silicate); diopside (calcium magnesium silicate); ulexite (hydrous sodium calcium borate); aragonite (calcium carbonate); and willemite (zinc silicate); mineral powders with blue fluorescence; examples of such minerals include dumortierite (aluminum borate silicate); scheelite (calcium tungstate); smithsonite (zinc carbonate); danburite (calcium boric silicate); benitoite (barium titanium silicate); fluorite (fluorospar); and halite. Other fluorescence categories include red or orange, as represented, for example in axinite (calcium aluminum borate silicate); scapolite (sodium calcium aluminum silicate); kyanite (aluminum silicate); sphalerite (zinc sulphite); calcite (calcium carbonate); petalite (lithium aluminum silicate); or yellow, as represented by apatite (basic fluoro- and chloro-calcium phosphate) or cerussite (lead carbonate)

The fluorescent materials may also be fluorescent brighteners. Commonly used organic fluorescent brighteners include compounds selected from the group consisting of organic compounds that are derivatives of stilbene and 4,4′-diaminostilbene, e.g., bistriazinyl derivatives; derivatives of benzene and biphenyl, e.g., styryl derivatives; pyrazolines, bis(benzoxazol-2-yl) derivatives, coumarins, carbostyrils, naphthalimides, s-triazines, pyridotriazoles, and the like. A review of commonly used fluorescent brighteners is found in “Fluorescent Whitening Agents”, Kirk-Othmer Encyclopedia of Chemical Technology, Fourth Edition, Volume 11, Wiley and Sons, 1994, the contents of which are incorporated herein by reference. The fluorescent material may also be an inorganic fluorescent glass, such as are described in U.S. Pat. Nos. 5,635,109, and 5,755,998, the contents of which are incorporated herein by reference. A wide variety of such compounds are available commercially from, for example, Keystone Aniline Corp. (Chicago, Ill.) Ciba Specialty Chemicals, (High Point, N.C.) and Sumita Optical Glass, Inc. (Saitama, Japan). A particular benefit of encapsulation of fluorescent brighteners is, first, that certain fluorescent brighteners, the 4,4′-diaminostilbene derivatives, can react with skin proteins, making them difficult to wash off the skin; encapsulation of the brightener prevents the brightener from binding to the skin. Second, not only does the brightener encapsulation not interfere with the fluorescence, it appears, as discussed in more detail below, to enhance its properties in reducing the appearance of lines and wrinkles. In addition, microspheres of different chemical compositions can modify the nature of the observed fluorescence (see Example 10)

The microspheres containing skin benefit agents can be used as described above in powder form for application to the skin, in the same way any powder may be applied, either alone, or formulated together with other powder components, such as fillers, binders, unencapsulated pigment powders and the like. Soluble entrapped actives can then be released gradually from the microsphere on the skin by the dissolving action of skin fluids, such as perspiration or oil; even insoluble materials may be drawn out by the action of fluids on the skin. The microspheres can also be incorporated into fluid formulations of any type. In formulating uncoated microspheres in fluid, a variety of different approaches can be used to prevent premature leaching of the agent from the microsphere. For example, the microspheres can be incorporated into a product that does not contain a solvent that will dissolve the agent; for example, microspheres containing a water soluble agent may be formulated in an anhydrous vehicle to prevent premature release of the agent. Alternatively, the vehicle can be provided with a sufficient amount of the agent to form an equilibrium between the agent in the microsphere and that in the product, so that there is no tendency for the agent to leach into the vehicle before application to the skin. Once on the skin, the agent in the vehicle provides an initial benefit, and then it is followed by the slow release of the entrapped agent in response to the skin fluids. The mechanical action of rubbing can also have the effect of releasing the agent from the microsphere onto the skin (see Example 11).

In a preferred embodiment, however, the microspheres are further treated by providing a polymeric coating on the surface which, depending upon the intended disposition of the agent, can either delay or prevent release of agent directly on to the skin. In one embodiment, a simple coating with a wax that melts at body temperature (for example, DC2501, available from Dow Corning) can be employed; this forms a light physical barrier on the microsphere which melts when rubbed onto the skin, allowing release of the entrapped agent.

In a particularly preferred embodiment, especially where the release of the agent directly onto the skin is not desired, the coating is a polymeric silicone, or a crosslinked polyvinyl alcohol. In one example of utilizing the polymeric silicone, a mixture of the starting silicone oligomer fluid, such as Dow Corning 1107® fluid (polymethyl hydrogen silicone oligomer), available from Dow Corning, and a catalyst in a volatile hydrocarbon solvent are contacted with the microspheres containing entrapped skin benefit agent, for example, by spraying or dispersion. The solvent is then evaporated off, forming in situ a permanent polymeric film on the surface of the microspheres. Alternately, a preformed polymeric silicone, such as methicone or dimethicone, can be applied to the surface of the microspheres in the same manner as these materials are routinely applied as pigment coatings, although such coatings are less permanent than the coating formed in situ, as they may be more susceptible to dissolution or removal by solvents in the formulation in which they are contained.

In an alternate embodiment, the coating is a crosslinked polyvinyl alcohol PVA). Crosslinked PVA is formed by suspension of PVA resin in cold water followed by heating and mixing until a clear colloidal solution is formed. The solution is then cooled and a dilute glyoxal solution is added as a crosslinker. The resulting crosslinked PVA is on its own a useful film-forming resin. It is then added to the microspheres, by, for example, spraying or dispersion, and the remaining solvent evaporated off to leave a film coating on the microspheres.

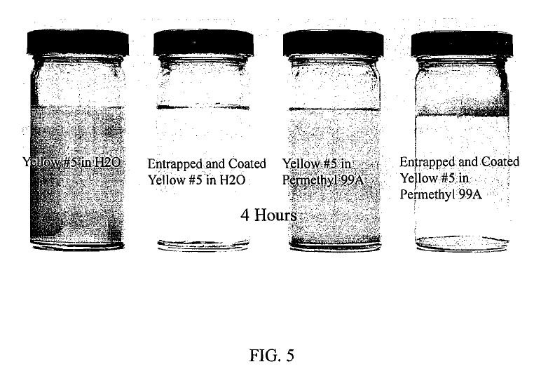

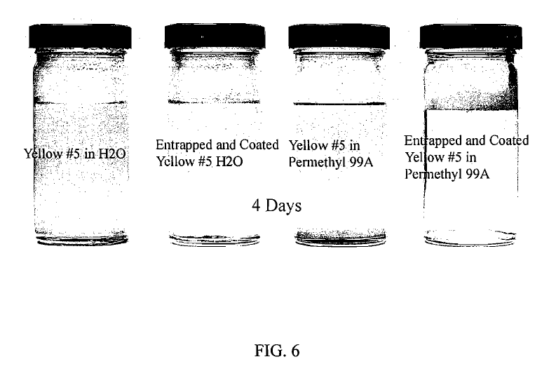

The addition of a coating, particularly the durable coatings such as the polymeric silicone provides an additional benefit in those situations in which it is desired to retain the skin benefit agent on the skin surface, where it can exert its beneficial effect, without it directly contacting the skin or migrating into the skin. In other words, the coating can prevent the leaching of the agent from the microsphere onto the skin. This is of particular benefit in connection with certain materials. For example, nano-sized particles of titanium dioxide or zinc oxide are particularly preferred for use in sunscreens because they don't create the opaque white look that traditional larger-sized particles do. However, because of their size, there is the possibility of migration into lower skin layers, where they will potentially not be as effective. The encapsulation of such particles in coated microspheres permits the particles to remain atop the skin, but not in contact with it; the encapsulated product retains its ability to protect the skin against UV rays, and cannot migrate from the top layer of skin to which it is applied. Coating also provides an advantage when used in conjunction with certain pigments, such as lakes, that have a tendency to bleed. Coating of encapsulated lakes substantially prevents bleeding of the colorant (see FIGS. 5 and 6).

A particular advantage in coating the microspheres is seen when the encapsulated active is a fluorescent brightener. Although silicone coatings can be effectively used with brighteners, the use of a crosslinked PVA provides an unexpected advantage, in that it actually intensifies the fluorescence of the particles overall. Crosslinked PVA, unlike uncrosslinked PVA, has a strong fluorescence of its own, and in combination with the fluorescent brightener, gives a much stronger fluorescence than is obtainable with uncoated encapsulated brightener.

The use of thermoplastic microspheres generally to entrap skin benefit agents provides several benefits. An important advantage is the ability to deliver relatively large quantities of potentially irritating but beneficial actives, such as alpha or beta hydroxyacids, benzoyl peroxide, hydroquinone, sunscreens, or retinoids. Because of the delayed release achievable with this system, efficacy of the active may be enhanced by providing a larger dose, while preventing or reducing the adverse reaction that might otherwise be observed with exposure to such a large, unencapsulated dose. As also noted above, coated microspheres provide a particularly useful means of keeping certain types of actives, such as sunscreens and colorants, in place on the skin surface without migration, while still retaining the active's efficacy.

Also, encapsulation can provide a means for stabilizing actives that otherwise are labile in certain environments, e.g., for actives that are susceptible to hydrolysis or degradation by interaction with other materials in the formulation. For example, as shown in Example 8 below, encapsulation of avobenzone (Parsol 1789), which is frequently paired with octylmethoxy cinnamate (OMC) in sunscreen formulations and is degraded by contact with OMC, results in a reduction of the degradation that is observed in OMC's presence, in comparison with the unencapsulated avobenzone. Coatings can also be chosen to add protection, e.g., a hydrophobic coating to protect a hydrophilic active in a hydrophilic environment, or to provide a physical means of photoprotection.

In addition to the utility of the microspheres containing actives, the coated microspheres, with or without actives, may provide a benefit in themselves. In particular, the polymeric silicone or cross-linked PVA-coated microspheres may contribute unique physical properties to a formulation, independently of any entrapped skin benefit agent. Coated microspheres can be used to stabilize an emulsion, with little or no added emulsifier. They also provide a means for syneresis stabilization, improved spreading properties, and enhanced formula longevity on the skin.

The modified thermoplastic microspheres as described herein can be used in any type of topical or ingestible cosmetic or pharmaceutical formulation such as anhydrous, aqueous, or water-and-oil containing compositions, such as emulsions. They can also be incorporated into any product form, such as creams, lotions, milks, ointments, gels (aqueous or anhydrous), pastes, mousses, sprays, sticks, dispersions, suspensions, and powders. Techniques for formulation of various types of vehicles are well known to those skilled in the art, and can be found, for example, in Chemistry and Technology of the Cosmetics and Toiletries Industry, Williams and Schmitt, eds., Blackie Academic and Professional, Second Edition, 1996 Harry 's Cosmeticology, Eighth Edition, M. Reiger, ed. (2000), and Remington: The Science and Practice of Pharmacy, Twentieth Edition, A. Gennaro, ed., (2003), the contents of each of these being incorporated herein by reference. The invention is further illustrated by the following non-limiting examples.

### EXAMPLES

In the following examples, four different types of thermoplastic microspheres are referred to, all available from Akzo Nobel. They are as follows:

Expancel 091 DE 40 d30

Expancel 551 DE 40 d42

Expancel 461 DE 20 d70

Expancel 551 DE 20 d60

The identity of the materials is further explained as follows:

The first three digits in the particle name identify the ratios of the component monomers. For example, “091” has the monomer composition: 0:9:1 ratio of PolyVinylidene chloride, PolyAcrylonitrile, PolyMethacrylonitrile respectively. 551 is 55:1 ratio of PolyVinylidene Chloride to Polyacrylonitrile. 461 is 46:1 ratio of Polyvinylidene Chloride to Polyacrylonitrile.

The “DE” designation identifies the material as “dry expanded”, and the “40” or “20” following it defines the median particle diameter in μm. The final designation “d_” indicates the particles' true density in kg³/m.

### Example 1

Expancel 091 DE 40 d30 microspheres of median particle size 40 microns are loaded with a salicylic acid/ethanol solution of 5.5 grams per gram (1.5 gram salicylic acid, 4 grams ethanol). The salicylic acid concentration in ethanol is 27%. The solution is made at ambient temperature and then adsorbed in Expancel by placing it in contact with the Expancel in a vessel and mixing the combination for about 30 minutes at about 10 rpm. Once a homogeneous system of particles is obtained, it is heated to about 50° C. under vacuum to remove the alcohol.

The dry sustained release composition is a white, fine powder, containing 60% by weight entrapped Salicylic Acid, i.e., 1.5 grams per gram of microspheres. Concentration is determined by ASTM D 281-31, or a method described in U.S. Pat. No. 4,962,170. The entrapped salicylic acid is delivered as a free-flowing powder. The powder can be used as is, or added to a formulation, preferably as a last step to avoid premature interaction with other ingredients.

### Example 2

Example 1 is repeated, except that Expancel 551 DE20 d60 microspheres of median particle size 20 microns were used. The same results are obtained.

### Example 3

A suspension is prepared by dispersing 2.8 grams of nano-sized titanium dioxide (available from KOBO Co.) in 10 grams of ethanol. The homogeneous suspension is adsorbed into 1 gram of the Expancel 091 DE 40 d30 microspheres, by contacting the dispersion with the microspheres at ambient temperature in a mixing device such as a stainless steel bowl and a spatula in a laboratory condition; a helical, pedal, plough type agitator; or twin-cone, or twin shell blenders in production scale, and mixed at 10 rpm until the titanium dioxide is evenly distributed in the Expancel microspheres, for about 30 minutes. Homogeneity is confirmed by the observance of no dry powder. The ethanol is then evacuated in a vacuum oven at 80° C. The resulting titanium dioxide composition is in form of a very fine, fluffy powder. The loading capacity of titanium dioxide in this experiment is 73.7%, i.e., 2.8 grams per one gram of microspheres.

The encapsulated titanium dioxide retains its ability to screen UV radiation, in a manner comparable to unencapsulated titanium dioxide. The encapsulated and unencapsulated forms are compared in the following in vitro SPF test.

Reagents and Materials: 1. Optometrics Group SPF-290 Analyzer 2. Labsphere UV Transmittance Analyzer UV-1000s 3. 3M Transpore tape 4. Fingercots 5. Plastic template with a 2.5 cm diameter hole 6. Positive displacement pipette 7. Pipette tips 8. Analytical balance

Control and sample preparation: 3M Transpore tape is mounted to a plastic template with a 2.5 cm diameter hole. The product is dotted on the test area and then spread with a gloved finger. Material application is at a dose of 2.0 mg/cm². The material is dried for 15 min. and the UV absorption curve is obtained. Both the control and sample are prepared in quadruplicate taking 1 measurement over the area of each preparation.

Calculation: A series of 4 measurements is obtained from each sample. The in-vitro SPF value is calculated in a Microsoft excel spreadsheet calculating the estimated in-vitro SPF using the following equation:
Est. in-vitro SPF=(avg. in-vitro apf value)−(T(one tail)×(standard deviation)/(√N),
where
T(one tail)=2.353 from table for In-Vitro SPF (N−1)=3
The results are as follows:

Control:

UVA/UVB ratio: 0.80

UVB area (SPF) 10.14

Expancel/TiO2:

UVA/UVB ratio: 0.76

UVB area (SPF): 12.25

The results show that the Expancel-entrapped TiO₂ provides an SPF value that is comparable to that of a non-entrapped TiO₂.

### Example 4

Similarly to Example 3, TiO₂ is entrapped in Expancel 551 DE 20 d60 of median particle size 20 microns. The same type of product is obtained.

### Example 5

The procedure of Example 3 is repeated except that Yellow #5 lakes are used. The same results are obtained.

### Example 6

Example 4 is repeated, except that Yellow #5 lakes are used. The same results are obtained.

### Example 7

The procedure of Example 5 is repeated, except that Expancel 551 DE 20 d60 of median particle size 20 microns was used. The same results are obtained.

### Example 8

A solution is prepared by dissolving 4 grams of Parsol 1789 (UV blocker) in 9 grams of Ethyl Acetate. The resulting solution is adsorbed in 1 gram Expancel 091 DE 40 d30 microparticles of median particle 40 microns. Then, the Ethyl Acetate is removed by heating to 50° C. under vacuum, and, because of some agglomeration upon drying, the resulting system is deaglomerated via sieving through #30 sieve.

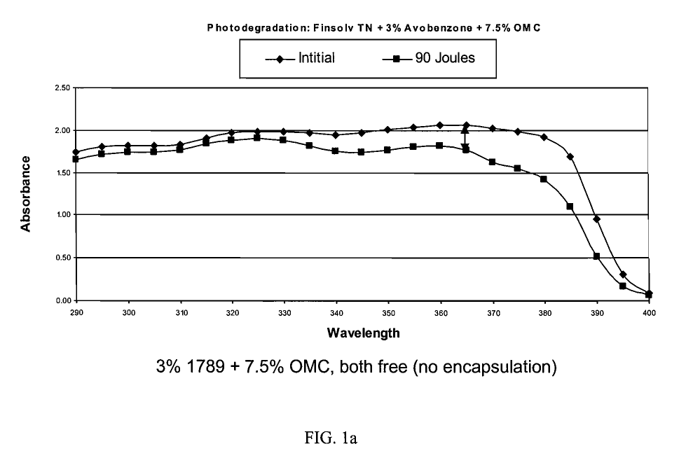

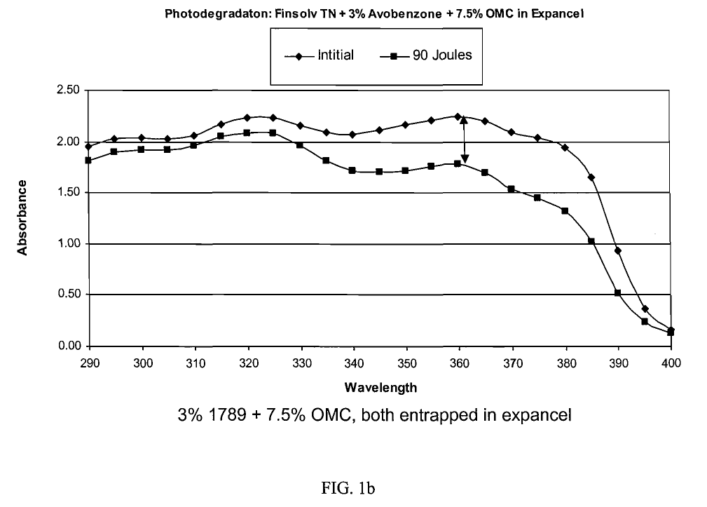

The purpose of entrapment is to chemically protect Parsol 1789, which is relatively unstable in the presence of certain other chemicals, such as octyl methoxycinnamate (OMC), another sunscreen. Experiments are conducted to compare the efficacy and stability of the encapsulated vs. unencapsulated Parsol 1789 when exposed to UV radiation. Three formulas are tested using the methodology described in Example 3, each containing 3% Parsol (1789) and 7.5% OMC in Finsolv TN. One formula contains both 1789 and OMC in unencapsulated form; a second contains both 1789 and OMC encapsulated together in Expancel, and the third contains unencapsulated OMC and Expancel-encapsulated 1789. The results, shown in FIG. 1, indicate that the Parsol 1789 that is physically separate from the OMC retains its UV absorbing properties better than Parsol 1789 that is in direct physical contact with the OMC (FIG. 1c).

### Example 9

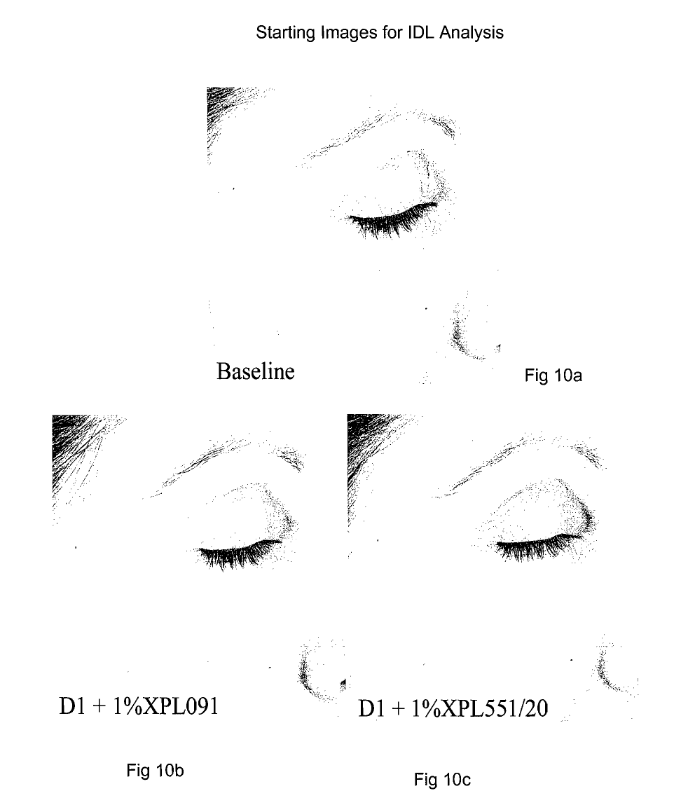

A liquid mixture is obtained by dissolving 1 gram of Leucophor BSB (Triazadiphenylethenesulfonate) fluorescent brightener (commercially available from Clariant Co.) in 19 grams of a 1:2 water/ethanol solution. The resulting mixture was adsorbed in 100 grams Expancel 091 DE 40 d30 microspheres of median particle size 40 microns, by contacting the microspheres with the brightener-containing liquid for about 20 minutes while mixing in a stainless steel bowl and spatula at ambient temperature. Then, the water/ethanol mixture is removed by vacuum and heating to about 70° C., leaving a free-flowing powder. The system can be used in cosmetic compositions to reduce the appearance of skin imperfections i.e. wrinkles, spots. The system emits blue light while exposed to long wave (365 nm) UV light. (see FIG. 10b)

### Example 10

The example 9 is repeated, except that Expancel 551 DE20 d60 of median particle size 20 microns is employed with the same fluorescent brightener. With the different microsphere, however, the system emits green light while exposed to long wave (365 nm) UV light. This phenomenon reduces excess of skin redness along with reducing of skin imperfections like wrinkles, spots. (see FIG. 10c).

### Example 11

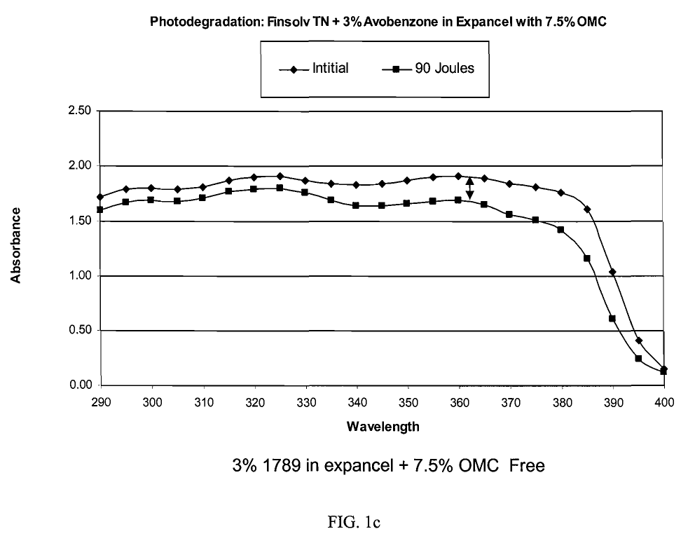

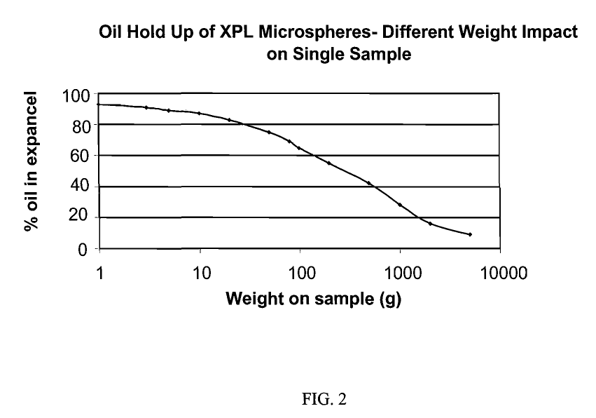

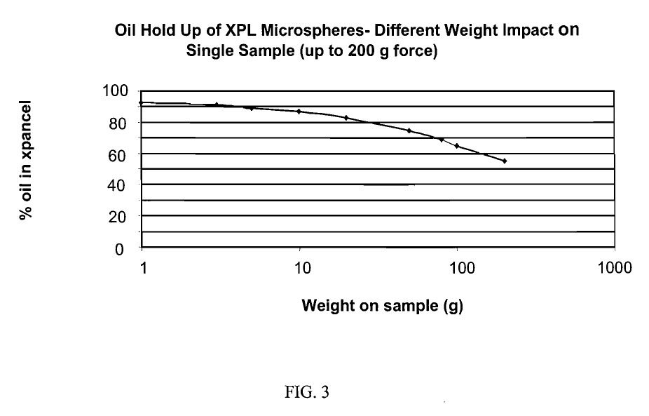

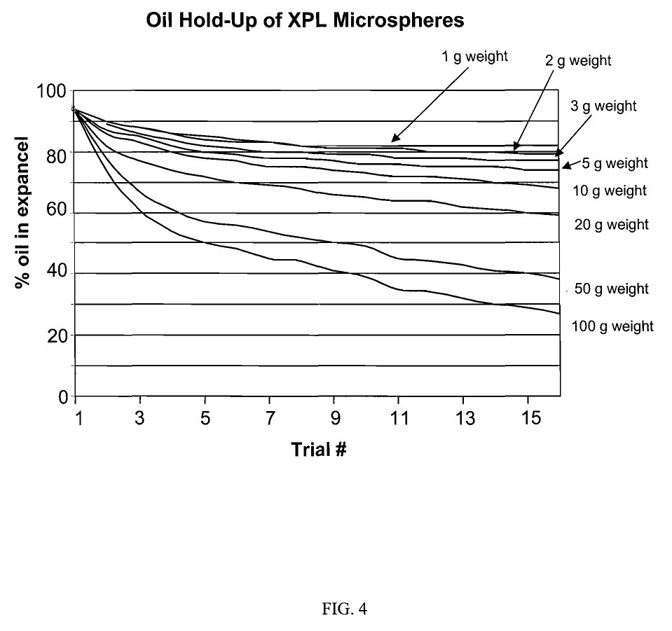

Jojoba oil is freely incorporated into Expancel 1091 DE40 d30 by mixing in ratio 17:1, i.e. 94% by weight of the jojoba oil. Mixing take place for about 20 minutes at ambient temperature. The system is submitted to sustained release study performed via weight impact of 1-8,000 grams (Texture Analyzer apparatus) in one scenario and repeated eight impacts on the only sample from 1 to 100 grams in another test. In brief, a filter paper is used to weigh up the oil spot that is expressed, as pressure is applied, from the sample located underneath of the Texture Analyzer. (see FIGS. 2, 3, and 4). The results shown confirm the controlled release of an active under a pressure, simulating the pressure of a hand rubbing the product on the skin (a hand having 50-75 grams impact on an emulsion rubbing into the skin). This type of system, with an uncoated microsphere containing a fluid, is particularly useful for controlled delivery and release of necessary liquids, such as water, oils, esters and other skin-beneficial fluids.

### Example 12

Water solution of Celvol 165 Polyvinyl Alcohol (commercially available from Celanese Co.) containing 4% of the polyvinylacohol is crosslinked via 3.5% Glyoxal solution (BASF Co.) The polyvinyl alcohol resin is dispersed in cold water via agitation with a propeller type agitator at 100 RPM and the system is heated to 95° C. while maintaining speed of mixing. The temperature of 95° C. is maintained until a clear colloidal solution is formed. Then the system is cooled down to 55° C. in order to perform crosslinking by adding a calculated amount of Glyoxal solution at 100 RPM. The system continues to be mixed at 55° C. for about half an hour, then the crosslinked polyvinyl alcohol (7.5% concentration) is allowed to cool down to ambient temperature. The product thus provided stabilizes the polyvinyl alcohol solution against uncontrollable self crosslinking, which limits the utility of the PVA, as it gradually increases in viscosity day by day if unchecked. The material so obtained has both fluorescence and excellent film forming properties. The crosslinked PVA is used as protective coating over entrapments in thermoplastic microspheres, as described in Example 14.

### Example 13

The product of Example 3 and 4, containing 73.7% of titanium dioxide entrapped in 26.3% of Expancel 091 and 551 DE 20 are stabilized by 5% silicone polymer that was obtained via in situ polymerization of Dow Corning 1107( Fluid (polymethylhydrogen silicone polymer) on the surface of the microspheres. The polymerization of the DC 1107 Fluid at room temperature is induced by adding stannous octoate as a catalyst to the fluid, in ratio of 10 parts of 1107 to 1 part of the catalyst. The DC 1107 and Stannous Octoate are dissolved in Hexane in 1:25 ratio and the mixture is sprayed over the entrapped titanium dioxide system. The solvent is removed under vacuum, and within 10 minutes after the solvent is removed, the catalytic polymerization of DC 1107 polymer is formed in situ as a membrane over the surface of the microspheres.

The Silicone polymer is similarly used as a coating material for products in Examples: 3, 4, 5, 6, 7, 8, 9 and 10 for the same purpose. A release study is conducted to confirm stability of the coated systems. Expancel-entrapped Yellow #5 as prepared in Example 5, is suspended in two common solvents, water and Permethyl 99A. These are compared with unentrapped yellow #5 in the same solvents for evidence of bleeding. The results (after 4 hours and 4 days) are shown in FIGS. 5 and 6. The results show considerable bleeding of the colorant into the solvent when the colorant is not entrapped, but the solvents in which the Expancel entrapped colorants are suspended remain substantially clear, indicating a lack of bleeding of the colorant.

### Example 14

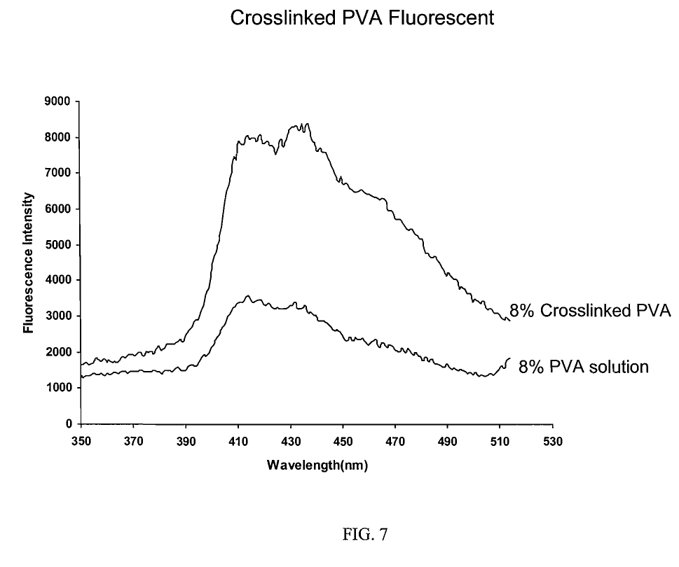

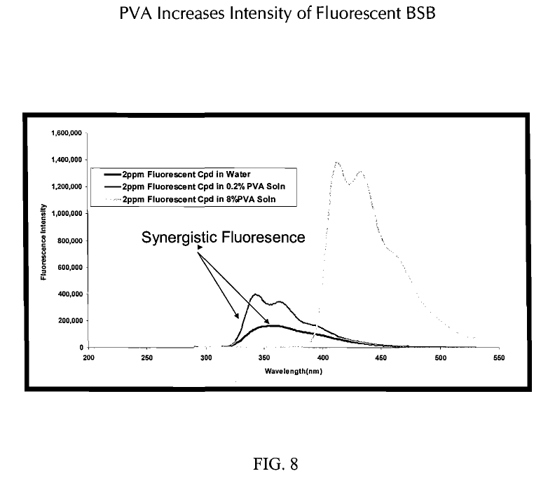

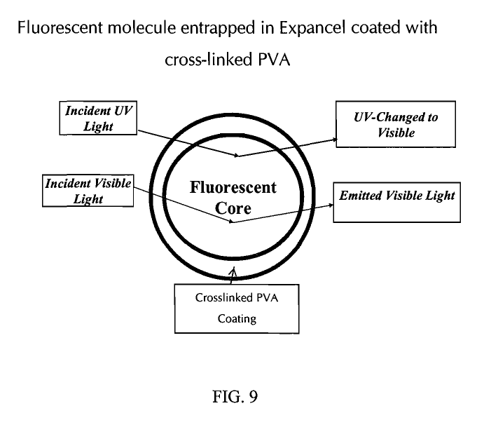

The products of Example 9 and 10 are overcoated with crosslinked PVA solution described in Example 12. The crosslinked PVA (that contains 7. 5% solid as calculated) is diluted with alcohol and the dispersion is sprayed and adsorbed on the surface of the substrate. The alcohol and water are then removed under vacuum and heating up to 50° C. This accomplishes the stabilization of the optical brightener inside the microsphere, and surprisingly intensifies fluorescent activity of the system. The fluorescent activity is increased via a combination of the fluorescent activity of crosslinked PVA and entrapped optical brightener in Expancel polymers. (FIGS. 7, 8 and 9). Without wishing to be bound by any theory, the crosslinked PVA, in addition to its individual fluorescent properties, may add to the system a “lens effect”, meaning that beams of the emitted light are concentrated and have higher energy. This effect produces an apparent synergy, since the system provides a much more pronounced fluorescence.

### Example 15

The following are the components for the compositions tested in Example 9 and 10:

| Ingredient | Placebo | 091 | 551/20 |
|---|---|---|---|
| water/phenyl trimethicone/ | 50.00 | 50.00 | 50.00 |
| cyclomethicone/ | | | |
| dimethiconol/phosphoglycerides/ | | | |
| carbomer/triethanolamine | | | |
| sodium dehydroacetate | 0.10 | 0.10 | 0.10 |
| disodium EDTA | 0.14 | 0.14 | 0.14 |
| Glycerine USP 99% Veg. | 3.00 | 3.00 | 3.00 |
| Aluminum starch octenylsuccinate | 1.00 | 1.00 | 1.00 |
| DI Water | 41.81 | 40.81 | 40.81 |
| Acrylates/C10-30 alkylacrylates crosspolymer | 0.30 | 0.30 | 0.30 |
| Carbomer | 0.35 | 0.35 | 0.35 |
| Glycerine USP 99% Veg. | 1.00 | 1.00 | 1.00 |
| Algin | 0.20 | 0.20 | 0.20 |
| DI water | 2.00 | 2.00 | 2.00 |
| Triethanolamine | 0.10 | 0.10 | 0.10 |
| Fluorescent Material in | | 1.00 | 1.00 |
| Expancel | | | |

What is claimed is:

1. A thermoplastic microsphere containing at least one skin benefit agent entrapped therein.

2. The microsphere of claim 1 which is coated with a polymeric silicone or a crosslinked polyvinyl alcohol.

3. The microsphere of claim 1 which is comprised of polymers or copolymers of alkenyl aromatic monomers, acrylate monomers or vinyl esters, a copolymer of vinyl chloride and vinylidene chloride, or a copolymer of acrylonitrile and vinyl chloride or vinyl bromide.

4. The microsphere of claim 2 which is comprised of polymers or copolymers of alkenyl aromatic monomers, acrylate monomers, or vinyl esters, a copolymer of vinyl chloride and vinylidene chloride, or a copolymer of acrylonitrile and vinyl chloride or vinyl bromide.

5. The microsphere of claim 3 in which the alkenyl aromatic monomer is selected from the group consisting of styrene, methylstyrene, ethylstyrene, aromatic vinyl-xylene, aromatic chlorostyrene, and aromatic bromostyrene.

6. The microsphere of claim 4 in which the alkenyl aromatic monomer is selected from the group consisting of styrene, methylstyrene, ethylstyrene, aromatic vinyl-xylene, aromatic chlorostyrene, and aromatic bromostyrene.

7. The microsphere of claim 3 in which the acrylate monomer is selected from the group consisting of methyl methacrylate, ethyl acrylate, propyl acrylate, butyl acrylate, butyl methacrylate, propylmethacrylate, butyl methacrylate, lauryl acrylate, 2-ethylhexyl acrylate, and ethyl methacrylate.

8. The microsphere of claim 4 in which the acrylate monomer is selected from the group consisting of methyl methacrylate, ethyl acrylate, propyl acrylate, butyl acrylate, butyl methacrylate, propylmethacrylate, butyl methacrylate, lauryl acrylate, 2-ethylhexyl acrylate, and ethyl methacrylate.

9. The microsphere of claim 3 wherein the vinyl ester is vinyl acetate.

10. The microsphere of claim 4 wherein the vinyl ester is vinyl acetate.

11. The microsphere of claim 3 which is comprised of a copolymer of vinyl chloride and vinylidene chloride, or a copolymer of acrylonitrile and vinyl chloride or vinyl bromide.

12. The microsphere of claim 4 which is comprised of a copolymer of vinyl chloride and vinylidene chloride, or a copolymer of acrylonitrile and vinyl chloride or vinyl bromide.

13. The microsphere of claim 1 which is comprised of acrylonitrile/methacrylonitrile/methylmethacrylate polymer, acrylonitrile/methacrylonitrile polymer or acrylonitrile/vinylidene chloride polymer.

14. The microsphere of claim 2 which is comprised of acrylonitrile/methacrylonitrile/methylmethacrylate polymer, acrylonitrile/methacrylonitrile polymer or acrylonitrile/vinylidene chloride polymer.

15. The microsphere of claim 1 wherein the skin benefit agent is an astringent, an anti-oxidant or free radical scavenger, an anti-acne agent, an antimicrobial agent, an antifungal agent, a chelating agent, a topical analgesic, an anti-aging/anti-wrinkle agent, a skin lightening agent, an antiirritant, an anti-inflammatory agent, an anti-cellulite agent, a skin-conditioning agent, a sun protecting agent, a self-tanning agent, a vitamin, a biologically active peptide, a colorant or pigment, or a fluorescent or other light emitting material.

16. The microsphere of claim 2 wherein the skin benefit agent is an astringent, an anti-oxidant or free radical scavenger, an anti-acne agent, an antimicrobial agent, an antifungal agent, a chelating agent, a topical analgesic, an anti-aging/anti-wrinkle agent, a skin lightening agent, an antiirritant, an anti-inflammatory agent, an anti-cellulite agent, a skin-conditioning agent, a sun protecting agent, a self-tanning agent, a vitamin, a biologically active peptide, a colorant or pigment, or a fluorescent or other light emitting material.

17. A composition suitable for topical application comprising thermoplastic hollow microspheres having at least one skin benefit agent entrapped therein.

18. The composition of claim 17 comprising thermoplastic hollow microspheres coated with a polymeric silicone or a crosslinked polyvinyl alcohol.

19. A method for delayed release of a skin benefit agent which comprises entrapping the skin benefit agent in a thermoplastic hollow microsphere, and applying the microsphere to the skin.

20. The method of claim 19 which comprises dispersing the skin benefit agent in a solvent; exposing the solvent containing the skin benefit agent to the microsphere for a time sufficient to obtain substantially homogenous absorption of the solvent containing the skin benefit agent by the microsphere; and evaporating at least a portion of the solvent.

21. The method of claim 20 wherein the solvent comprises ethanol, a hydrocarbon, an ester or a volatile silicone.

22. The method of claim 21 wherein the hydrocarbon is hexane or heptane, the ester is ethyl acetate, and the volatile silicone is cyclomethicone or low molecular weight dimethicone.

23. The method of claim 22 wherein the microsphere is comprised of polymers or copolymers of alkenyl aromatic monomers, acrylate monomers, or vinyl esters, a copolymer of vinyl chloride and vinylidene chloride, or a copolymer of acrylonitrile and vinyl chloride or vinyl bromide.

24. The method of claim 23 wherein the microsphere is comprised of acrylonitrile/methacrylonitrile/methylmethacrylate polymer, acrylonitrile/methacrylonitrile polymer or acrylonitrile/vinylidene chloride polymer.

25. The method of claim 19 wherein the microsphere is coated with a polymeric silicone or a crosslinked polyvinyl alcohol.

26. A thermoplastic hollow microsphere which is coated with a polymeric silicone or a crosslinked polyvinyl alcohol.
